(19) United States
(12) Patent Application Publication
(10) Pub. No.: US 2024/0183005 A1
(43) Pub. Date: Jun. 6, 2024

(54) Method for dissolving a positive electrode material

(71) Applicants: COMMISSARIAT À L'ÉNERGIE ATOMIQUE ET AUX ÉNERGIES ALTERNATIVES, Paris (FR); ORANO, Chatillion (FR)

(72) Inventor: Emmanuel Billy, Grenoble (FR)

(21) Appl. No.: 18/553,250

(22) PCT Filed: Mar. 28, 2022
(86) PCT No.: PCT/FR2022/050578

§ 371 Date: Sep. 29, 2023

(30) Foreign Application Priority Data
Mar. 30, 2021 (FR) FR2103264

(51) Int. Cl. C22B 47/00; C01G 45/02; C22B 3/00; C22B 3/08; C22B 3/22; C22B 3/44; C22B 7/00; C22B 21/00; C22B 26/12; H01M 10/54

(52) U.S. Cl. CPC C22B 47/00; C01G 45/02; C22B 3/08; C22B 3/22; C22B 3/44; C22B 7/007; C22B 21/0023; C22B 23/043; C22B 23/0461; C22B 26/12; H01M 10/54; C01P 2006/40

(57) ABSTRACT

A method for dissolving a positive electrode material of a battery including a step during which the positive electrode material, comprising lithium and optionally cobalt and/or nickel, is submerged in an acid solution having a pH between 0 and 4, the acid solution containing either manganese ions or hydrogen peroxide, by means of which the lithium and optionally the cobalt and/or nickel is dissolved, and the manganese ions are selectively precipitated in the form of manganese oxyhydroxide.

### TECHNICAL FIELD

The present invention relates to the general field of recycling of lithium batteries and more particularly to the recycling of Li-ion type batteries.

The invention relates to a method for dissolving a positive electrode material, for recycling thereof and recovery of the metallic elements that compose it.

The invention is particularly interesting since the extraction efficiency of these elements is very high and the method is quick and simple to implement.

### PRIOR ART

The market for lithium accumulators (or batteries), in particular of the Li-ion type, is nowadays in strong growth, in particular with nomadic applications (“smartphone”, power tools . . . ) and with the emergence and development of electric and hybrid vehicles.

Lithium-ion accumulators comprise a negative electrode, a positive electrode, a separator, an electrolyte and a case (“casing”) which may be a polymer pocket, or a metal packaging. In general, the negative electrode is made of graphite mixed with a PVDF-type binder deposited over a copper foil. The positive electrode is a lithium ion insertion material (for example, LiCoO₂, LiMnO₂, Li₃NiMnCoO₆, LiFePO₄) mixed with a polyvinylidene fluoride type binder deposited over an aluminium foil. The electrolyte consists of lithium salts (LiPF₆, LiBF₄, LiClO₄) dissolved in an organic base formed from mixtures of binary or ternary solvents based on carbonates.

The operation is as follows: during charging, the lithium is deintercalated from the active material of the positive electrode and is inserted into the active material of the negative electrode. During discharge, the process is reversed.

Given the environmental, economic and strategic issues in the supply of some metals (in particular copper, cobalt, nickel and lithium), it is essential to be able to recycle at least 50% of the materials contained in Li-ion batteries and accumulators (Directive 2006/66/EC).

Currently, to recover the valuable elements contained in the batteries, manufacturers generally use a process implementing a combination of physical, thermal and chemical methods.

For example, the physical methods consist in dismantling the batteries, grinding them and then sieving the ground matter thus obtained.

The thermal methods are based on pyrometallurgical processes consisting in heating the residues at high temperature to separate the metals in the form of slag or alloys. However, these thermal methods are energy-intensive because they require temperatures that could reach 1,400° C. In addition, while being very effective in separating cobalt, nickel and copper, they do not allow recovering manganese and lithium.

Chemical methods are used to recover valuable elements in a pure form. These consist of hydrometallurgical processes implementing reagents in the liquid phase to dissolve and/or to precipitate the metals. Conventional leaching uses highly concentrated acids. This step allows completely dissolving the electrode materials to be recovered, in an ionic form. The leachate thus obtained contains mixed metal ions such as lithium, cobalt, nickel, manganese ions, etc. Afterwards, chemical processes are necessary to recover the valuable elements in a pure form.

However, manganese, cobalt and nickel are close elements on the periodic table and their chemistry is very similar, making the selective separation of these metals difficult and expensive (from an economic and environmental point of view).

For illustration, the document WO 2005/101564 A1 describes the recycling of cells and batteries with a hydrometallurgical treatment process. The process comprises the following steps: dry grinding, at room temperature and under an inert atmosphere, then treatment by magnetic separation and densimetric table, and aqueous hydrolysis, in order to recover the lithium, for example in the form of carbonate. The fine fraction freed from soluble lithium and including the valuable elements is dissolved in a 2N sulphuric medium at a temperature of 80° C. in the presence of steel shot. After purification, the cobalt is recovered by precipitation by adding sodium hypochlorite, with regulation of the pH to a value comprised between 2.3 and 2.8. This method is used for a solution rich in cobalt (>98%) and with a very low manganese concentration (<2%). For a solution that is both rich in cobalt and manganese, electrolysis is carried out at a temperature of 55° C. under a current density comprised between 400 and 600 A/m².

However, the use of hypochlorite is detrimental to the facilities, the safety and therefore increases the cost of the process. In addition, it is necessary to know the manganese concentration in order to select the appropriate process.

In the document EP 2 532 759 A1, the method for recovering metals from ground lithium batteries or battery elements comprises the following steps:
leaching the ground matter in an acid medium so as to obtain a solution containing metal ions,
separating the metal ions from the obtained solution on a first cation exchange resin, preferably on a sulphonic resin, to obtain a solution of lithium ions, a nickel, cobalt and/or manganese solution, and a final solution of aluminium ions,
separating the solution of nickel and cobalt and manganese ions on a second cation exchange resin so as to obtain a solution of nickel and cobalt ions, and a solution of manganese ions.

For example, the elution of the nickel and cobalt ions is carried out with a solution complexing the nickel and/or cobalt ions, for example with the aminopolycarboxylic acid.

For example, the elution of the manganese ions is carried out with a mineral acid at a concentration of 2N to 4N.

However, ion-exchange resins are relatively expensive, and need to be regenerated. Their use generates a lot of effluents, long treatment times and high acid consumption.

In the document US 2019/0152797 A1, a method allows recovering, from battery waste, sulphates of nickel, of manganese, of lithium and cobalt oxides. The method consists in dissolving battery waste with acid, then selectively separating iron and aluminium, then calcium, magnesium and copper. The separation steps are based on extraction by solvent and crystallisation by evaporation. The recovered products have a high purity.

However, the extraction by solvent (or liquid/liquid extraction) requires several steps for each element (extraction in the organic solvent, stripping from the organic solvent, crystallisation) and therefore involves many products such as, for example, kerosene, sulphuric acid and hydrochloric acid. Such a method is long to implement and generates a large amount of effluents, making it difficult to industrialise, from an economic and environmental point of view.

Another method is described in the document FR3034104 A1. In this method, a mixed lithium oxide is partially dissolved in an acid solution (acid concentration comprised between 0.001M and 2M). To complete the reaction, a metal reducing agent of the copper or aluminium type is added to the solution. The reducing metal added to the solution has a redox potential lower than that of the mixed oxide, to promote the dissolution of the latter. The electronic ratio of reducing metal/metal oxide is 1/2, so as to complete the dissolution of the metal oxide.

However, this method does not enable the complete dissolution of the material simultaneously with the selective recovery of the manganese.

Yet, manganese has a low economic interest and should imperatively be removed upstream to avoid impacting the purity of the recovered cobalt, nickel and lithium (purity of 99.99%).

All these methods have an approach that involves the complete dissolution of the material to be recovered by the addition of a reducing agent in liquid or solid form. After dissolution, separation steps are necessary to recover the manganese and the other elements.

### DISCLOSURE OF THE INVENTION

The present invention aims to provide a method for dissolving a positive electrode material, overcoming the drawbacks of the prior art, the method having to be simple to implement, with a low environmental impact.

For this purpose, the present invention proposes a method for dissolving a positive electrode material of a battery including a step during which the positive electrode material, including lithium and possibly cobalt and/or nickel, is immersed in an acid solution at a pH comprised between 0 and 4,
the acid solution further containing either manganese ions or hydrogen peroxide, whereby the lithium and possibly the cobalt and/or the nickel are put in solution and, where appropriate, the manganese ions are selectively precipitated in the form of manganese oxyhydroxide.

The invention differs fundamentally from the prior art by the implementation of a hydrometallurgical method during which an electrode to be recycled is immersed in a so-called leaching or dissolving solution containing manganese ions or hydrogen peroxide.

Upon completion of the leaching step, the metals of interest such as lithium, nickel and/or cobalt are in the ionic form, and the manganese is in the form of a solid oxyhydroxide MnO(OH).

The leaching/dissolution method allows recycling the positive electrode materials of batteries, of all electrochemical systems, which may contain manganese, of the accumulator or cell type treated separately or as a mixture. In particular, the method may be used for various battery chemistries (NCA, NMC with different proportions, for example, 1/1/1, 5/3/2, 6/2/2, 8/1/1 or 9/0.5/0.5). This recycling and recovery method is robust and has good manganese separation yields for different types of battery waste. By nature, it should be understood the chemistry of the positive electrode, which varies according to the manufacturers.

Advantageously, the positive electrode material further comprises manganese. When such a positive electrode material is immersed in the acid solution, the manganese of the positive electrode is dissolved in solution, in the form of additional manganese ions, the additional manganese ions then selectively precipitating as manganese oxyhydroxide.

This method allows selectively, quickly and efficiently recovering manganese from an electrode containing lithium and possibly other elements, like cobalt and/or nickel, even though the chemistry of manganese and that of these elements are very similar.

Conventionally, during the dissolution of the positive electrode material, a dilithiation is observed, which increases the potential of the electrode material. The electrode material is then covered with a thin layer of manganese oxide. For illustration, in the case of particles of NMC-type electrode material, a MnO₂ shell covering an NMC core is obtained. It is then no longer possible to continue the dissolution reaction. A portion of the material cannot be recovered because the dissolution is not complete.

The addition of hydrogen peroxide or manganese ions makes it possible to continue the dissolution reaction and to obtain a manganese oxyhydroxide.

Thus, the dissolution of battery wasted (preferably ground batteries) leads in one single step to the leaching of the metals contained in this waste and to the selective separation of the manganese.

Advantageously, the manganese of the positive electrode material is entirely recovered in the form of manganese oxohydroxide.

According to a first advantageous variant, the leaching solution contains manganese ions. In particular, it is Mn(II).

Advantageously, the manganese ions are obtained by dissolving a manganese salt.

Advantageously, the manganese salt is a manganese sulphate salt.

Advantageously, the manganese salt is introduced in stoichiometric proportion or in excess with respect to the metals of the positive electrode material. For example, it is comprised between 1 g/L and 10 g/L.

According to a second advantageous variant, the leaching solution contains hydrogen peroxide (H₂O₂). Advantageously, the reaction with hydrogen peroxide is exothermic, which avoids heating the solution.

Advantageously, the volume concentration of hydrogen peroxide is comprised between 0.1% and 16%, preferably between 1% and 12% (for example between 1% and 10%), and even more preferably between 1% and 6% (for example between 1% and 4%). By comprised between 1% and 4%, it should be understood that the bounds are included. The same applies to the ranges described herein and later on.

Advantageously, the solid/liquid (S/L) ratio is comprised between 5% and 40%, and advantageously between 5% and 30% (for example between 15% and 30%), preferably between 5% and 20% (for example 10%). The solid corresponds to the mass (g) of the positive electrode material (typically lithium mixed oxide) and the liquid to the volume (mL) of the solution.

Advantageously, the pH is comprised between 0.5 and 2.5 and preferably between 1 and 2.5. For example, it is 2.

Advantageously, the volume concentration of hydrogen peroxide is selected according to the S/L ratio. Advantageously, the ratio between the volume concentration of hydrogen peroxide and the solid/liquid ratio is comprised between 0.1 and 0.4 and preferably between 0.2 and 0.3.

Such concentrations are sufficient, on the one hand, to dissolve at least 90% and even completely the lithium and possibly the cobalt and/or the nickel in solution and, on the other hand, to completely dissolve the manganese and make it precipitate in the form of a solid manganese oxyhydroxide. These conditions avoid putting the manganese into solution and thus facilitate separation thereof from the other elements of the solution.

Advantageously, the solid/liquid ratio is comprised between 5% and 40% and the volume concentration of hydrogen peroxide is comprised between 1% and 12%.

Quite advantageously, the solid/liquid ratio is comprised between 5% and 20% and the volume concentration of hydrogen peroxide is comprised between 1% and 6%.

According to another quite advantageous variant, the solid/liquid ratio is comprised between 5% and 10%, the pH is comprised between 1 and 2.5 and the volume concentration of hydrogen peroxide is comprised between 1% and 3%. For example, for a solid/liquid (S/L) ratio, a volume concentration of hydrogen peroxide comprised between 2% and 3% will be selected.

Advantageously, the positive electrode is an NMC, NCA or LCO electrode.

Advantageously, the temperature of the solution is comprised between 70° C. and 100° C., preferably between 80° C. and 95° C., and even more preferably between 80° C. and 85° C.

Advantageously, the solution is stirred.

Advantageously, the positive electrode material is in a particulate form.

The method has numerous advantages:
carrying out in one single step the dissolution and the separation of manganese from a complex matrix which sometimes contains iron, aluminium, copper, and carbon impurities,
being able to process many chemistries of positive electrodes containing manganese, electrodes of the same chemistry or of different chemistries being able to be processed as a mixture,
being able to be implemented under moderate conditions, with an acid solution that is easy to make (the used acids are easily found on the market),
requiring few steps and fewer reagents, compared to the methods of the prior art, and therefore generating less effluents to be treated,
having a very good yield,
obtaining a product with good purity.

Other features and advantages of the invention will appear from the following complementary description.

It goes without saying that this complementary description is given only for illustration of the object of the invention and should in no way be interpreted as a limitation of this object.

### BRIEF DESCRIPTION OF THE DRAWINGS

The present invention will be better understood upon reading the description of embodiments given for purely indicative and non-limiting purposes with reference to the appended drawings wherein:

FIG. 1 is a graph showing the dissolution yield of an NMC powder (1/1/1) in a sulphuric acid solution at pH=1 with stoichiometric manganese sulphate, at a temperature of 72° C., with an S/L ratio of 20%, with stirring at 400 rpm, as a function of time, according to a first variant of the method of the invention,

FIG. 2 is a graph showing the concentration of ions in the solution as a function of time during the treatment of an NMC powder (6/2/2) in a sulphuric acid solution at pH=2.5 with manganese sulphate at a temperature of 100° C. with an S/L ratio of 20%, with stirring at 400 rpm, according to a second variant of the method of the invention.

FIG. 3 is a graph showing the dissolution yield of the ions, Li, Ni, Mn, Co as a function of the volume concentration of hydrogen peroxide at different concentrations, after 24 h of treatment of an NMC powder (1/1/1), in a sulphuric acid solution at pH=1 at a temperature of 80° C. with an S/L ratio of 10%, under stirring at 400 rpm, according to another variant of the method of the invention.

FIG. 4 is a graph showing the dissolution yield of the ions, Li, Ni, Mn, Co as a function of the volume concentration of hydrogen peroxide at different concentrations, after 24 h of treatment of an NMC powder (6/2/2), in a sulphuric acid solution at pH=1 at a temperature of 80° C. with an S/L ratio of 10%, under stirring at 400 rpm, according to another variant of the method of the invention.

FIG. 5 is a graph showing the dissolution yield of the ions, Li, Ni, Mn, Co as a function of the volume concentration of hydrogen peroxide at different concentrations, after 24 h of treatment of an NMC powder (8/1/1), in a sulphuric acid solution at pH=1 at a temperature of 80° C. with an S/L ratio of 10%, under stirring at 400 rpm, according to another variant of the method of the invention.

### DETAILED DISCLOSURE OF PARTICULAR EMBODIMENTS

The invention particularly finds applications in the field of recycling and/or recovery of batteries/accumulators/cells of the Li-ion type, and in particular of their electrodes.

Next, reference will be made to a battery, but it could consist of a cell or an accumulator.

Next, by battery waste, it should be understood the battery or a portion of the battery that has been recovered after safeguarding and dismantling the battery.

The battery waste comprises lithium and possibly cobalt and/or nickel.

According to a particularly advantageous embodiment, the waste battery further comprises manganese.

The battery waste may also comprise aluminium.

In particular, the battery waste is a positive electrode whose active material may be LiCoO₂ (lithium cobalt oxide (LCO)), LiMnO₂, LiNiO₂, LiNiCoAlO₂ (nickel-cobalt-aluminium (NCA)) or LiNiₓMn_{y}Co_{z}O₂. (NMC (nickel-manganese-cobalt)).

Preferably, an NMC or LiMnO₂ electrode will be selected. The NMC electrode may have different ratios of nickel, cobalt and manganese. For example, the ratio may be 1/1/1, 5/3/2, 6/2/2, 8/1/1 or 9/0.5/0.5.

The battery waste may further contain other species. The other species may be metals, alkali metals and/or rare-earth elements. As an illustrative and non-limiting example, mention may be made of the following elements: Fe, Zn, Al, Mg, Cu, Ca, Pb, Cd, La, Ti, V, Nd and Ce.

Advantageously, the battery waste is ground before the dissolution step, whereby a ground matter is formed. For example, the particles of the ground matter have a largest dimension smaller than 1 cm.

Alternatively, the method may also be carried out directly on unground battery waste.

It is also possible to carry out one or more material concentration step(s) (such as sieving, eddy current, etc.).

The method for dissolving a battery positive electrode material according to the invention includes the following steps:
providing a positive electrode material including lithium and, possibly, cobalt and/or nickel and/or manganese,
carrying out a leaching step by immersing the positive electrode material in an acid solution at a pH comprised between 0 and 4, containing either manganese ions or hydrogen peroxide or a mixture of manganese ions and hydrogen peroxide, whereby the lithium and possibly the cobalt and/or the nickel are put into solution and, where appropriate, the manganese ions are selectively precipitated in the form of manganese oxyhydroxide.

Advantageously, with such a method, different electrode materials can be treated simultaneously as a mixture.

The method according to the invention also allows treating a concentrated powder of positive electrode material which has been obtained, for example, after a step of separating the active material from the current collector.

The selective dissolution phase ensures complete dissolution of valuable elements (lithium, nickel and/or cobalt) and, where appropriate, the separation of manganese in one single step.

The positive electrode material (preferably NMC, LiMnO₂), preferably in the form of powder, is introduced in a solid/liquid ratio of 5% to 40%, and advantageously between 15% and 30% (g/mL).

Preferably, the solution is an aqueous solution. It could also consist of an organic solution.

Advantageously, the acid is selected from among mineral acids, for example from hydrochloric acid, phosphoric acid, nitric acid, sulphuric acid or a mixture thereof. Preferably, sulphuric acid will be selected since it is the least corrosive for the materials used in the method, it has fewer dangers during use thereof and it is easily available, at a relatively low cost.

The pH is comprised between 0 and 4, preferably between 1 and 2.5. For example, a pH of 2 will be selected.

Advantageously, a servo-control device is used to maintain a constant pH (within a 10% margin) throughout the treatment.

According to a first variant, the leaching solution contains a manganese salt. Advantageously, the manganese salt is added in a stoichiometric amount or in excess to ensure a complete dissolution.

Advantageously, the manganese salt may be a salt of manganese chloride, manganese nitrate, manganese sulphate. Advantageously, these salts have a good solubility in water. Preferably, a manganese sulphate salt will be selected, to avoid the presence of nitrate or of chloride in solution.

It could also consist of manganese hydroxide.

According to a second variant, the leaching solution contains hydrogen peroxide. Preferably, the volume concentration of hydrogen peroxide is comprised between 0.1% and 16%, and preferably between 1% and 12%, for example between 1% and 10%.

According to one variant, the leaching solution further contains a manganese salt. Advantageously, the manganese salt may be a salt of manganese chloride, manganese nitrate, manganese sulphate. Advantageously, these salts have a good solubility in water. Preferably, a manganese sulphate salt will be selected, to avoid the presence of nitrate or of chloride in solution. It could also consist of manganese hydroxide.

Advantageously, the volume concentration of hydrogen peroxide will be selected according to the S/L ratio. Preferably, the ratio between the volume concentration of hydrogen peroxide and the S/L ratio is comprised between 0.1 and 0.4, and even more preferably between 0.2 and 0.3.

For illustration, the following table reports different volume concentrations of hydrogen peroxide associated with different S/L ratios that can be used to implement the method:

| S/L | Volume concentration of | Preferred volume concentration of |
|---|---|---|
| ratio (%) | hydrogen peroxide (%) | hydrogen peroxide (%) |
| 1 | 0.1-0.4 | 0.2-0.3 |
| 5 | 0.5-2 | 1-1.5 |
| 10 | 1-4 | 2-3 |
| 20 | 2-8 | 4-6 |
| 25 | 2.5-10 | 5-7.5 |
| 40 | 4-16 | 8-12 |

The duration of the leaching step may be comprised between 1 h and 24 h. The duration of the leaching step can be adapted according to the temperature of the solution. The temperature of the solution may be comprised between 70° C. and 110° C., for example between 70° C. and 100° C., preferably in the vicinity of 80° C. to 85° C. With such temperatures, the duration of the treatment is for example in the range of 3 h.

Preferably, the pressure during the leaching step is the atmospheric pressure (in the range of 1 bar).

The method may include another step during which another element present in the solution to be treated and having a high added value is advantageously recovered.

In particular, upon completion of the leaching step, the cobalt, lithium and/or nickel ions will advantageously be recovered. It is also possible to recover the aluminium.

For example, it is possible to separate the nickel ions, by precipitation in a basic medium by increasing the pH between 7 and 10, by adding a base such as NaOH, NH₄OH or Na₂CO₃, whereby the nickel is precipitated.

### ILLUSTRATIVE AND NON-LIMITING EXAMPLES OF ONE EMBODIMENT

### Example 1: Treatment of NMC in a (1/1/1) Ratio: Complete Dissolution of the Electrode Material and Extraction of Manganese

16 g of a powder of a cathode material of the NMC type as well as 20 g of manganese sulphate in a powder form are immersed in 80 mL of sulphuric acid with a servo-control at pH=1 at 72° C. The solid (NMC powder)/liquid ratio is 20% (g/mL). The mixture is stirred at 400 rpm for 24 hours. Afterwards, the mixture is centrifuged and filtered, and the residual solid is washed with deionised water. Thus, it is possible to put all of the lithium, cobalt and nickel into solution after 7 hours of leaching.

FIG. 1 shows the dissolution kinetics of the NMC electrode in the sulphuric acid solution. One could notice a drop in the manganese concentration which changes from the ionic state in solution into a manganese oxyhydroxide solid whereas at the same time there is a dissolution of lithium, nickel and cobalt. When the manganese has completely reacted, the state is stationary. The mass composition of the manganese precipitate is largely enriched in Mn, with a cobalt and nickel residue. Where necessary, the manganese precipitate may be totally pure by adapting the amount of manganese sulphate.

The mass composition of the metals in the manganese residue is reported in the following table:

Composition (mass %)

| Mn | Ni | Co | Li |
|---|---|---|---|
| 51.5 | 2.5 | 3.7 | 0.2 |

### Example 2: Treatment of NMC in a (6/2/2) Ratio: Complete Dissolution of the Electrode Material and Extraction of Manganese

16 g of a powder of a cathode material of the NMC type as well as 9 g of manganese sulphate in a powder form are immersed in 80 mL of sulphuric acid with a servo-control at pH=2.5 at 100° C. The solid (NMC powder)/liquid ratio is 20% (g/mL). The mixture is stirred at 400 rpm for 24 hours. Afterwards, the mixture is centrifuged and filtered, and the residual solid is washed with deionised water. Thus, it is possible to put all of the lithium, cobalt and nickel into solution after 3 hours of leaching.

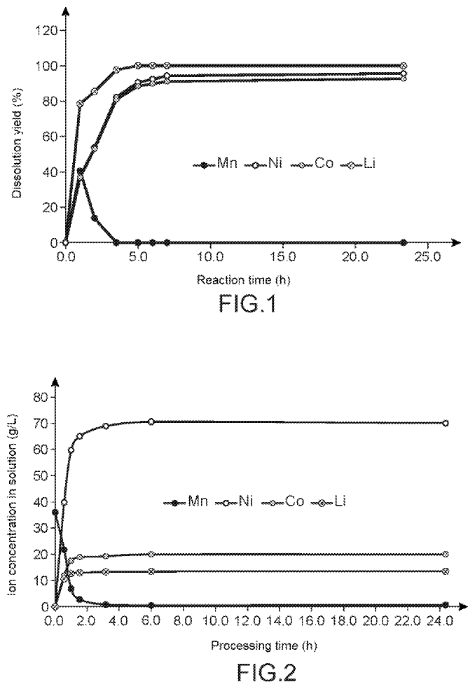

FIG. 2 shows the dissolution kinetics of the NMC electrode in the sulphuric acid solution. One could notice a decrease in manganese which passes from the ionic state in solution into a manganese oxyhydroxide solid. Simultaneously, one could observe the dissolution of lithium, nickel and cobalt. When the manganese has completely reacted, the state is stationary. The mass composition of the manganese precipitate is largely enriched in Mn, with a cobalt residue. Where necessary, the manganese precipitate may be totally pure by adapting the amount of manganese sulphate.

The mass composition of the metals in the manganese residue is reported in the following table:

Composition (mass %)

| Mn | Ni | Co | Li |
|---|---|---|---|
| 55.6 | 0.8 | 1.7 | 0 |

### Example 3: Treatment of NCA: Complete Dissolution of the Electrode Material and Extraction of Manganese

3.2 g of a powder of a cathode material of the NCA type as well as 2 g of manganese sulphate in the form of powder are immersed in 80 mL of sulphuric acid with a servo-control at pH=2 and 76° C. The solid (NCA powder)/liquid ratio is 4% (g/mL). The mixture is stirred at 400 rpm for 1 hour. Afterwards, the mixture is centrifuged and filtered, and the residual solid is washed with deionised water. The composition of the residue is analysed, and indicates a manganese precipitate with a residue of the NCA metals. Where necessary, the manganese precipitate may be totally pure by adapting the amount of manganese sulphate.

The mass composition of the metals in the manganese residue is reported in the following table:

Composition (mass %)

| Mn | Ni | Co | Li | Al |
|---|---|---|---|---|
| 54 | 1.3 | 3.4 | 0.1 | 0.1 |

### Example 4: Treatment of NMC in a (8/1/1) Ratio: Complete Dissolution of the Electrode Material and Extraction of Manganese

3.2 g of NMC and 1.3 g of manganese sulphate in a powder form are immersed in 80 mL of sulphuric acid with a servo-control at pH=1 and 85° C. The solid-to-liquid ratio is 4%. The mixture is stirred at 400 rpm for 1 hour. Afterwards, the mixture is centrifuged and filtered, and the residual solid is washed with deionised water. The composition of the residue is analysed, and indicates a precipitate of manganese with traces of metals. Where necessary, the manganese precipitate may be totally pure by adapting the amount of manganese sulphate.

The mass composition of the metals in the manganese residue is reported in the following table:

Composition (mass %)

| Mn | Ni | Co | Li | Al |
|---|---|---|---|---|
| 59.9 | 0.12 | 0.25 | 0.1 | 0.1 |

### Example 5: Treatment of NMC in a (1/1/1) Ratio: Selective Dissolution of Nickel, Cobalt and Lithium and Extraction of Manganese with Control of the H₂O₂ Supply

Several tests have been carried out to study the influence of the concentration of hydrogen peroxide. The other parameters are identical for each test. The volume concentrations of hydrogen peroxide are 0% vol, 2% vol, 4% vol and 6% vol. The amount of H₂O₂ is transcribed in volume percentage with respect to the amount of liquid.

8 g of NMC in the form of a powder are immersed in 80 mL of a sulphuric acid solution (pH=1), with constant servo-control to guarantee maintenance thereof. The temperature in the bath is 80° C. and the solid-to-liquid ratio is 10% (kg·L⁻¹). The mixture is stirred at 400 rpm for 24 hours. Afterwards, the mixture is centrifuged and filtered. Then the residual solid is washed with deionised water. Thus, it is possible to put all of the lithium, cobalt and nickel into solution within a few hours of leaching.

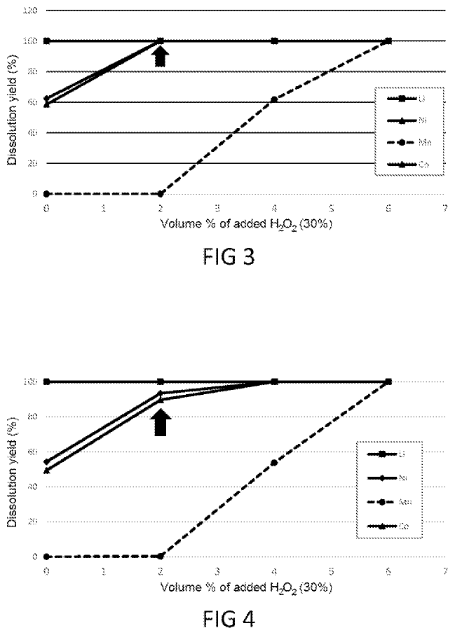

FIG. 3 shows the yield of the dissolution of the NMC electrode in the sulphuric acid solution according to the added volume percentage of H₂O₂ at 30%. It has been observed that not all concentrations allow achieving a complete dissolution of cobalt and nickel, and simultaneously the precipitation of manganese (i.e. absence of manganese in the solution).

For the test with the NMC 111 chemistry and for these treatment conditions, the optimum is determined at 2% by volume (arrow on the graph). For a lower concentration, the dissolution is incomplete, which is detrimental to the efficiency of the method. For a higher concentration, there is a concomitant dissolution of the manganese which does not allow removing it completely.

This example confirms the importance of the choice of the hydrogen peroxide concentration to obtain an extraction in the form of a manganese solid (% extraction of 0%) and a complete dissolution (namely 100%) for the cobalt elements, nickel and lithium.

### Example 6: Treatment of NMC in a (6/2/2) Ratio: Selective Dissolution of Nickel, Cobalt and Lithium and Extraction of Manganese with Control of the H₂O₂ Supply

Like before, in these different tests, only the volume concentration of hydrogen peroxide is modified (0% vol, 2% vol, 4% vol and 6% vol). The amount of H₂O₂ is transcribed in volume percentage with respect to the amount of liquid.

8 g of NMC in the form of a powder are immersed in 80 mL of water composed of sulphuric acid, allowing reaching a pH=1, with a constant servo-control to guarantee maintenance thereof. The temperature in the bath is 80° C. and the solid-to-liquid ratio is 10% (kg·L⁻¹). The mixture is stirred at 400 rpm for 24 hours. Afterwards, the mixture is centrifuged and filtered. Then the residual solid is washed with deionised water. Thus, it is possible to put all of the lithium, cobalt and nickel into solution within a few hours of leaching.

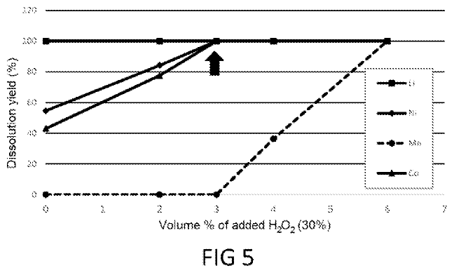

FIG. 4 shows the dissolution yield of the NMC electrode in the sulphuric acid solution according to the volume percentage of H₂O₂. One could notice an optimum for achieving a complete dissolution of cobalt and nickel, with absence of manganese in the solution. For the test with the NMC 622 chemistry and for these treatment conditions, the optimum is determined in the vicinity of 2% by volume (arrow on the graph). For this test, a person skilled in the art will adapt the amount for a totally optimised reaction. Nevertheless, one could observe that for a lower concentration, the dissolution is incomplete, which is detrimental to the efficiency of the method. For a much higher concentration, there is a concomitant dissolution of the manganese which does not allow removing it completely.

### Example 7: Treatment of NMC in a (8/1/1) Ratio: Selective Dissolution of Nickel, Cobalt and Lithium and Extraction of Manganese with Control of the H₂O₂ Supply

This example combines five tests carried out under conditions where only the volume concentration of hydrogen peroxide changes (0% vol, 2% vol, 3% vol, 4% vol and 6% vol). The amount of H₂O₂ which is transcribed in volume percentage with respect to the amount of liquid.

8 g of NMC in the form of a powder are immersed in 80 mL of water composed of sulphuric acid, allowing reaching a pH=1, with a constant servo-control to guarantee maintenance thereof. The temperature in the bath is 80° C. and the solid-to-liquid ratio is 10% (kg·L⁻¹). The mixture is stirred at 400 rpm for 24 hours. Afterwards, the mixture is centrifuged and filtered, and the residual solid is washed with deionised water. Thus, it is possible to put all of the lithium, cobalt and nickel into solution within a few hours of leaching.

FIG. 5 shows the dissolution yield of the NMC electrode in the sulphuric acid solution according to the volume percentage of H₂O₂. One could notice an optimum for achieving a complete dissolution of cobalt and nickel (i.e. 100%), with the absence of manganese in the solution (% extraction in solution of 0%).

For the test with the NMC 811 chemistry and for these treatment conditions, the optimum is determined in the vicinity of 3% by volume (arrow on the graph). Nevertheless, one could observe that for a lower concentration, the dissolution is incomplete, which is detrimental to the efficiency of the method. For a much higher concentration, there is a concomitant dissolution of the manganese which does not allow removing it completely.

What is claimed is:

1. A method for dissolving a positive electrode material of a battery comprising a step during which the positive electrode material, including lithium, manganese and possibly cobalt and/or nickel, is immersed in an acid solution at a pH comprised between 0 and 4,
wherein the acid solution contains hydrogen peroxide, whereby, on the one hand, the lithium and possibly the cobalt and/or the nickel are put into solution and, on the other hand, the manganese is dissolved, which selectively precipitates in the form of a manganese oxyhydroxide.

2. The method according to claim 1, wherein the manganese of the positive electrode material is entirely recovered in the form of manganese oxohydroxide.

3. The method according to claim 1, wherein the duration of the leaching step is between 1 h and 24 h.

4. The method according to claim 1, wherein the volume concentration of hydrogen peroxide is between 1% and 12%, and preferably between 1% and 6%.

5. The method according to claim 4, wherein the volume concentration of hydrogen peroxide is between 1% and 4%.

6. The method according to claim 5, wherein the volume concentration of hydrogen peroxide is between 2% and 3%.

7. The method according to claim 1, wherein the pH is between 1 and 2.5.

8. The method according claim 1, wherein the solid/liquid ratio is between 5% and 40%, and advantageously between 5% and 20%.

9. The method according to claim 1, wherein the ratio between the volume concentration of hydrogen peroxide and the solid/liquid ratio is between 0.1 and 0.4 and preferably between 0.2 and 0.3.

10. The method according to claim 1, wherein the positive electrode is an NMC electrode.

11. The method according to claim 1, wherein the temperature of the solution is between 70° C. and 100° C., preferably between 80° C. and 95° C.

12. The method according to claim 1, wherein the positive electrode material is in a particulate form.

13. The method according to claim 1, wherein the solid/liquid ratio is between 5% and 40% and the volume concentration of hydrogen peroxide is between 1% and 12%.

14. The method according to claim 13, wherein the solid/liquid ratio is comprised between 5% and 20% and the volume concentration of hydrogen peroxide is between 1% and 6%.

15. The method according to claim 1, wherein the solid/liquid ratio is between 5% and 10%, the pH is comprised between 1 and 2.5 and the volume concentration of hydrogen peroxide is between 1% and 3%.
